(19) United States
(12) Patent Application Publication
(10) Pub. No.: US 2014/0058933 A1
(43) Pub. Date: Feb. 27, 2014

(54) SMART STREET LAMP

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN); SHUANG RUI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/975,357

(22) Filed: Aug. 25, 2013

(30) Foreign Application Priority Data
Aug. 27, 2012 (CN) 2012103070806

(51) Int. Cl. G06Q 20/10

(52) U.S. Cl. CPC G06Q 20/102
USPC 705/40

(57) ABSTRACT

A street lamp includes a lighting unit, an input unit configured to receive bill information, a communication unit configured to communicate with a server, a display unit, a cash receiving unit configured to receive payment and a controlling unit. The controlling unit controls the communication unit to send the bill information received by the input unit to the server. The communication unit receives a payment amount sent back by the server. The controlling unit controls the display unit to display the payment amount and controls the communication unit to send a finish signal to the server after the cash receiving unit receives full payment. The street lamp has payment function that enable user to pay various bills without any manual intervention of the branch officer.

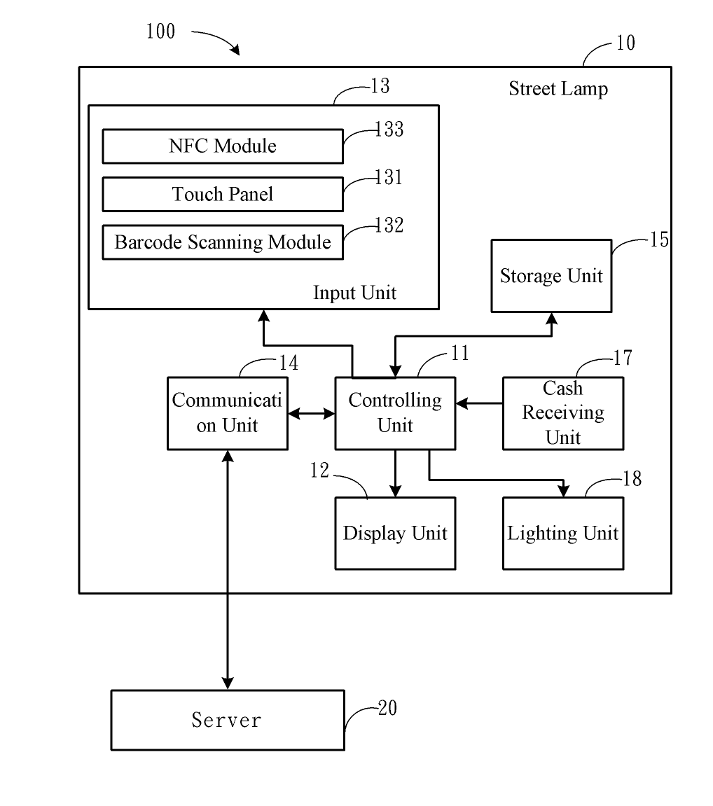

### BACKGROUND

1. Technical Field

The present disclosure relates to street lamps, and particularly to a street lamp with payment function.

2. Description of Related Art

Street lamps are a public facility in cities. The conventional street lamps are only configured to provide lighting. Some other street lamps include a monitoring system with function of urban monitoring, road surface monitoring and traffic monitoring. However, people cannot use the street lamps to pay bills, such as electricity bill, water account and the like bills.

Therefore, there is a need to improve the street lamps to make them with payment function.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

The figure is a block diagram of a street lamp, according to an exemplary embodiment.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

The figure shows a payment system 100 of the embodiment. The payment system 100 uses a number of street lamps 10. The street lamps 10 communicate with the server 20 via wired technology, wireless technology, or the combination of wired technology and wireless technology. For example, the street lamps 10 transmit data to the server 20 via power lines by using Power Line Communication (PLC), or via optical fiber power lines by using Optical fiber Power Line Communication (OPLC). For another example, the street lamps 10 can transmit data directly to the server 20 via Internet, 3G, 4G, GPRS, CDMA, or GSM mobile network technologies. In this embodiment, the server 20 is a computer terminal In other embodiments, the server 20 is a cloud server.

The street lamp 10 includes a controlling unit 11, a display unit 12, an input unit 13, a communication unit 14, a storage unit 15, a cash receiving unit 17 and a lighting unit 18. In this embodiment, the lighting unit 18 is a lamp for providing lighting, such as light-emitting diode (LED), or Sodium lamp. The communication unit 14 is configured to communicate with the server 20.

In this embodiment, the input unit 13 includes touch panel 131, the touch panel 131 is a transparent touch layer covering the display unit 12. The input unit 13 receives bill information input by users. The bill information includes a type of bill, a name on the bill, for example. A number of bill types are displayed on the display unit 12, users selects the type of the bill to be paid via the touch panel 131 by choosing the corresponding bill type displayed on the display unit 12. The payer name of the bill can be a user name, an identification code (ID), an order number, or a serial number, for example.

In this embodiment, the bill information can be a barcode of the bill, the input unit 13 further includes a barcode scanning module 132 configured to scan the barcode of the bill. In other embodiments, the input unit 13 further includes a Near Field Communication (NFC) module 133 configured to read an identification card with NFC chip, to obtain a name of the bill.

The controlling unit 11 is configured to control the communication unit 14 sending the bill information to the server 20. The server 20 obtains a payment amount from a corresponding charging system according to the bill information, and sends the payment amount to the street lamp 10.

The communication unit 14 of the street lamp 10 receives the payment amount. The controlling unit 11 controls the display unit 12 to display the payment amount.

The cash receiving unit 17 is configured to receive payment. In this embodiment, the cash receiving unit 17 is an electronic funds transfer at point of sale (EFTPOS) terminal or Credit Card swipe, the cash receiving unit 17 transfers electronic funds based on the use of payment cards, such as debit cards and credit cards, to receive payment. In other embodiments, the cash receiving unit 17 can be a Cash Deposit Machine (CDM).

The controlling unit 11 controls the communication unit 14 to send a finished signal to the server 20 when the cash receiving unit 17 receives full payment, and controls the display unit 12 to display a “payment was successful” message.

With such configuration, the street lamps 10 have payment function that enable user to pay various bills without any manual going into the bank.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A street lamp comprising:
a lighting unit configured to provide lighting;
an input unit configured to receive bill information;
a communication unit configured to communicate with a server;
a display unit;
a cash receiving unit configured to receive payment;
a controlling unit configured to control the communication unit to send the bill information received by the input unit to the server;
wherein the communication unit receives a payment amount sent back by the server, the controlling unit controls the display unit to display the payment amount and controls the communication unit to send a finish signal to the server after the cash receiving unit receives full payment.

2. The street lamp as described in claim 1, wherein the input unit comprises a touch panel configured to receive user's input of the bill information.

3. The street lamp as described in claim 1, wherein the input unit comprises a barcode scanning module configured to scan the barcode of the bill.

4. The street lamp as described in claim 1, wherein the input unit comprises a Near Field Communication module configured to read an identification card with NFC chip, thereby to obtain a name of the bill.

5. The street lamp as described in claim 1, wherein the cash receiving unit is an electronic funds transfer at point of sale (EFTPOS) terminal or Credit Card swipe.

6. The street lamp as described in claim 1, wherein the cash receiving unit is a Cash Deposit Machine.
